(19) United States
(12) Patent Application Publication
(10) Pub. No.: US 2002/0120692 A1
(43) Pub. Date: Aug. 29, 2002

(54) System and method for conducting predefined transactions via an electronic mail messaging infrastructure

(76) Inventors: Vincent J. Schiavone, Berwyn, PA (US); James H. Koenig, Philadelphia, PA (US); Cedarampattu Mohan, Yardley, PA (US)

Correspondence Address: Gregory S. Bernabeo, Esquire, Synnestvedt & Lechner LLP, 2600 Aramark Tower, 1101 Market Street, Philadelphia, PA, 19107-2950, US

(21) Appl. No.: 09/793,233

(22) Filed: Feb. 26, 2001

(51) Int. Cl. G06F 15/16

(52) U.S. Cl. 709/206

(57) ABSTRACT

An electronic mail transaction system for rule-based processing of e-mail messages to conduct predefined transactions via an electronic mail messaging infrastructure. Rules are defined for conducting various transactions. Senders and/or receivers specify a rule selected from among a common set of accepted rules. Preferably, each rule provides for automated retrieval of at least some required data elements from a data store. The data store may be stored privately, which protects the privacy of users of the system. Senders and receivers can then conduct transactions according to the predefined rules, which standardizes and facilitates the transactions. Establishment, management and/or approval of rules by a trusted third party intermediary protects and engenders trust in users of the system and facilitates order and efficiency. The system permits users to conduct transactions without a continuous network connection, i.e., in “burst” mode or asynchronously, which conserves network resources, heightens convenience and reduces costs to users.

### FIELD OF THE INVENTION

This invention relates generally to the field of electronic mail and particularly to a system for conducting predefined transactions via a communications network.

### BACKGROUND OF THE INVENTION

Communications networks, such as the Internet, are now being widely used internationally for sending and receiving predominantly textual electronic mail (“e-mail”) messages. While e-mail has long been used for personal matters, it is now being heavily used for customer relationship management (“CRM”), marketing and/or commercial (collectively, “commercial”) purposes.

A simplified explanation of electronic mailboxes, electronic mail addresses, and the operation of a typical e-mail system is provided in U.S. application Ser. No. ______ (Attorney Docket No. P24618 USA), filed ______, now U.S. Pat. No. ______, issued ______, the disclosure of which is incorporated herein by reference.

Presently, e-mail is a free-form communications tool typically used for correspondence and original commercial messages. Few standards, conventions, or laws (collectively, “standards”) apply to govern how the e-mail communications medium is used and, to the extent such standards exist, there are no common e-mail formats, elements, structures, layouts or conventions that can be used to systematically conduct, process or filter common transactions, communications or actions. The lack of standards reduces the efficiency of e-mail as a communications tool and as well as for transactional purposes, i.e., for commercial transactions and/or for any predetermined structured purpose. For example, it is possible for a buyer to communicate with a seller via e-mail to complete a sales transaction. However, there are no standards that govern use of e-mail to facilitate sales or other electronic commerce (“e-commerce”) transactions via e-mail in a standardized manner. Accordingly, lengthy textual discussions via e-mail must take place, possibly resulting in missing elements of required information, typographical errors, and inefficient use of time.

A substantial amount of e-commerce is now conducted via a World Wide Web-based interface. For example, a buyer may purchase a book from Amazon.com, Inc. of Seattle, Wash., U.S.A. through a website maintained by Amazon.com, Inc. at URL http://www.amazon.com. A buyer conducts a purchase transaction by selecting appropriate hyperlinks and/or typing appropriate information into electronic forms displayed via the website on a video monitor of a buyer's computer. Such a purchase transaction is typical of current e-commerce transactions in that a continuous connection to a communications network is required. Such an arrangement may be disadvantageous because of the cost, lack of spontaneity or inconvenience to the buyer where such a transaction requires increments of network connection time. This is particularly true of handheld personal digital assistants, such as a Palm VII® device. Additionally, many prospective buyers may have an electronic mail-based connection, e.g., an Internet connection, and yet do not have the capability to use a Web-based interface, or have a limited ability to use a Web-based interface. This limitation is typical of Web-enabled wireless telephones, personal digital assistants, pagers and other asynchronous messaging devices.

Accordingly, it would be desirable to have a transaction system for conducting transactions via electronic mail in a structured, pre-defined way, which standardizes transactions and allows them to be conducted easily and efficiently.

### SUMMARY OF THE INVENTION

The present invention provides an electronic mail transaction system and method that provides for rule-based processing of electronic mail. Generally, the system provides for conducting of predefined transactions via electronic mail messaging, i.e. an electronic mail communications infrastructure. The structure for the predefined transaction is set forth in a rule. The rule requires an associated electronic mail message to include at least one data element, which can be used to negotiate (i) the conducting of a transaction, (ii) delivery routing or filtering of messages or (iii) other action. Rules can be defined, for example by a third party, to enable a broad range of transactions.

In accordance with the present invention, senders and receivers can specify a rule selected from among a specified rule base or a common set of accepted rules as applicable to a given electronic mail message. E-mail senders and receivers can then conduct transactions according to the predefined rules, which standardizes, simplifies and facilitates the transactions and eliminates the need for free-form communications.

Establishment, management and/or approval of rules by a trusted third party intermediary protects and engenders trust in users of the system and facilitates order and efficiency. Data can be assembled from private profile information, which protects the privacy of users of the system. The system permits users to conduct transactions without a continuous network connection, i.e., in “burst” mode or “asynchronously,” which conserves network resources, heightens convenience and reduces costs to users. Finally, the system permits transactions to be conducted exclusively via the predominantly textual electronic mail medium, rather than via a Web-based medium, enabling participation of a broader base of users. Violators of the system guidelines can be barred from using the system, which protects users of the system.

The method generally involves identifying a rule applicable to an electronic mail message, communication, transaction or other action. As contemplated herein, both the data (sender and/or recipient) and the rule base used in the negotiation (whether such negotiation occurs at the ESP, recipient client or network or otherwise) can be stored at a trusted authority, corporate network, ESP and/or otherwise on a distributed basis. In accordance with the rule, it is determined whether data corresponding to that data element is absent from said electronic mail message. If so, appropriate data is retrieved from a data store and the electronic mail message is modified to include that data.

Devices for carrying out the inventive method and a system including such devices are also provided.

### DESCRIPTION OF THE DRAWINGS

FIG. 1 is a flow diagram of an exemplary rule-based electronic mail transaction in accordance with a first embodiment of the present invention, shown from a sender's perspective;

FIG. 2 is a flow diagram of the transaction of FIG. 1, shown from a recipient's perspective;

FIG. 3 is a flow diagram of an exemplary rule-based electronic mail transaction in accordance with a second embodiment of the present invention, shown from the sender's perspective; and

FIG. 4 is a block diagram of an electronic mail transaction system in accordance with the present invention.

### DETAILED DESCRIPTION

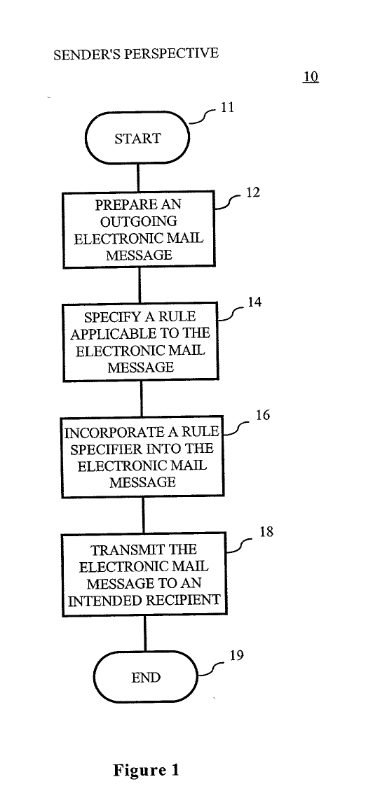

FIG. 1 is a flow diagram 10 of an exemplary rule-based electronic mail transaction in accordance with a first embodiment of the present invention. FIG. 1 is shown from a sender's perspective. As shown in FIG. 1, the transaction begins with preparation of an outgoing electronic mail message, as shown at steps 11 and 12. This can be performed with an appropriate communications device storing and running appropriate mail composing or instant messaging software, as is well known in the art. Examples of such devices include a general-purpose personal computer, a Web-enabled wireless telephone, a wireless personal digital assistant such as a Palm VII® device, a pager, etc.

A rule is then specified, i.e. associated, as applicable to the electronic mail message, as shown at step 14. The rule requires the associated electronic mail message to include data corresponding to at least one data element. In the example of FIG. 1, the rule will be used by the recipient to identify data in compliance with the rule. The rule is selected from a set of rules shared or followed by one or more subscribers, i.e. participants in the system such as a sender or a receiver, to the electronic mail transaction system. The rule specifies data elements required for the negotiation and conducting of an electronic mail transaction in accordance with the rule. When preparing a message, a sender may be required to select a type of class of standardized e-mail communication (personal, CRM, transactional, billing or other common classifications), where each such type of class is automatically associated with a recognized rule or rule base. Also, a rule may be specified automatically by the sender's communications device. Alternatively, the sender may type a rule specifier or keyword into a body portion of the message. In another embodiment, a graphic seal developed by an industry trade group, a consumer group or a trusted authority may signify application of a corresponding rule or rule base. In yet another embodiment, the sender may select a rule from a menu of rules displayed on the sender's communications device. In a preferred embodiment, a computer or other communications device configured with software for presentation of such a menu. Such software may be implemented with programming techniques well known in the art.

For illustrative purposes, consider a rule for conducting a money order transaction for sending $100 to a recipient. When the sender of an electronic mail message wishes to send a money order to a recipient via electronic mail, the sender composes a message addressed to the recipient, for example, a message reading “Happy Birthday!”. The sender then specifies that the money order rule is applicable to the electronic mail message.

Next, the rule is associated with the message. For example, the rule may be included in, i.e. embedded, in the message. In the example of FIG. 1, the rule is linked or generally associated with the message by embedding a rule specifier is embedded in the message, as shown at step 16. For example, the specifier may be inserted into a viewable content portion of the message, subject line or new message field used for such purposes, or embedded in hidden header information of the message. For illustrative purposes, consider that a rule specifier of “MO-100” is embedded in a header information portion of the message. The rule specifier may be used to reference a data store of rules to identify a corresponding rule.

Finally, the electronic mail message is transmitted to an intended recipient via a communications network, as shown at step 18, as is well known in the art. Various security safeguards, such as PKI encryption, digital signatures, etc. can be used for all communications in connection with the present invention. The transaction then ends, as shown at step 19.

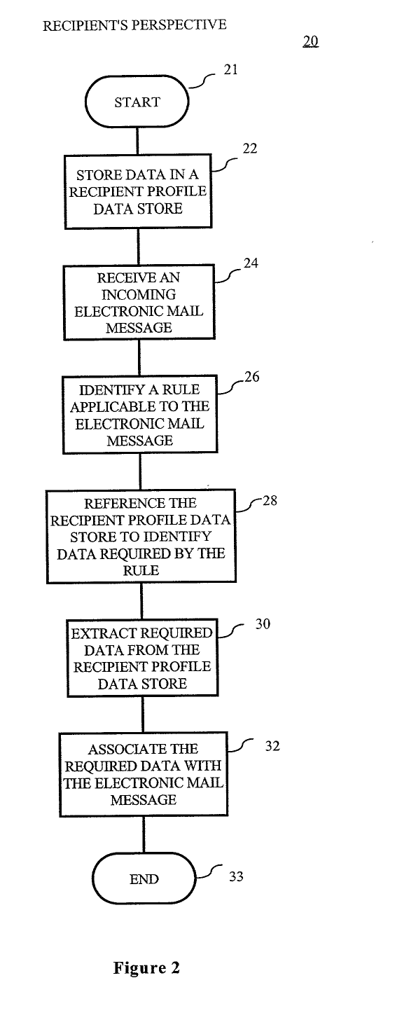

FIG. 2 is a flow diagram 20 of the transaction of FIG. 1, shown from a recipient's perspective. As shown in FIG. 2, the transaction starts with the recipient's storage of data in a recipient profile data store, as shown at steps 21 and 22. The recipient profile data store stores data specific to the recipient. This information is typically generic, rather than application or transaction specific. Accordingly, such information differs from a “cookie” of the type generally known in communications networks. For example, the recipient profile data store may store the recipient's name, residential address, residential telephone number, work address, work telephone number, age, sex, favorite color, marital status, social security number, birth date, primary bank account number, the primary bank's ABA routing number for electronic funds transfers, credit card number, etc. It should be appreciated that such information could be used for a wide variety of transactions with a number of diverse parties vendors, service providers, direct marketers, etc. The recipient profile data store may be stored locally, i.e., in the memory of the recipient's communications device, or remotely, e.g., on a server at a corporate domain, ESP, trusted authority or other storage device accessible via a communications network. It is advantageous to store the recipient profile data store locally to ensure that confidentiality of the data is preserved.

As shown in FIG. 2, the recipient (or an intermediary ESP, corporate domain or other location where the negotiation is to occur) next receives the electronic mail message, as shown at step 24. The electronic mail message may be received via a communications device and/or software that is well known in the art.

The recipient's communications device (or the device of an appropriate intermediary) next identifies a rule applicable to the electronic mail message, as shown at step 26. This step may be readily accomplished by programming techniques well known in the art. For example, this may involve scanning the message for a rule or a rule specifier, such as a keyword, image, etc. In the example of FIG. 2, the message includes a rule specifier. For example, the rule specifier may be contained in a body portion, subject line, a new message field for such purposes, or a header portion of the electronic mail message. Step 26 includes referencing a data store of rules to identify a corresponding respective rule. The data store of rules may be stored locally, e.g., in a memory of the recipient's communications device, or remotely, e.g. on a device accessible via a communications network (whether such location is at an ESP, trusted authority or other location on a distributed basis).

Implicitly, this step involves identifying data elements required by the rule applicable to the electronic mail message. For illustrative purposes, consider that the money order rule associated with rule specifier MO-100 requires the following data elements: the RECIPIENT FULL NAME, the RECIPIENT'S BANK ACCOUNT NUMBER, and the RECIPIENT'S BANK'S ABA ROUTING NUMBER to effect an electronic funds transfer to the recipient's bank account. Each of these data elements are specific to the money order transaction and generic as to the recipient. None of these data elements need to be supplied by or known to the sender (although the sender would need an electronic mail address for the recipient and a source from which the sender draws funds). The rule ensures that all this information will be compiled so that the mail order transaction can be given effect. This represents an improvement over free-form e-mail communications of the prior art, in which one or more of these data elements may have been inadvertently omitted from an e-mail message intended to effect the transaction.

The recipient profile data store is then referenced to identify and retrieve recipient-specific data for each required data element, as shown in step 30. For example, this may involve “sniffing” the data store. For illustrative purposes, consider that the recipient's full name is John F. Doe, his bank account number is 12345 and his source is a bank having an ABA routing number of 67890.

Finally, the data associated with the data elements required by the rule are then associated with the electronic mail message, as shown at step 32. For example, this may involve displaying the data in association with the electronic mail message, e.g. via the recipient's communications device. For example, the money order could appear as a check or bank draft showing the recipient as the payee and bearing the appropriate account and routing number information. In another embodiment, the data could be stored in association with the electronic mail message, e.g. in a memory of the recipient's communications device. In yet another embodiment, the electronic mail message could be modified to include the data associated with the data elements required by the rule, e.g., by appending the data to the message (e.g. inserted in the header, subject line, body of the message or otherwise associated with the message), and the modified electronic mail message could then be transmitted from the recipient via the communications network, e.g., to the recipient's bank, e.g., at an electronic mail address retrieved from the recipient profile data store. In yet another embodiment, the rule could require retrieval of data from a data store storing data specific to a party other than the recipient, e.g., the sender, the recipient's accountant or funds manager, or a third party. Such data may optionally be used for delivery, filtering, routing and/or other purposes. Various security safeguards, such as PKI encryption, digital signatures, etc. can be used for all communications in connection with the present invention.

The transaction then ends, as shown at step 33 of FIG. 2.

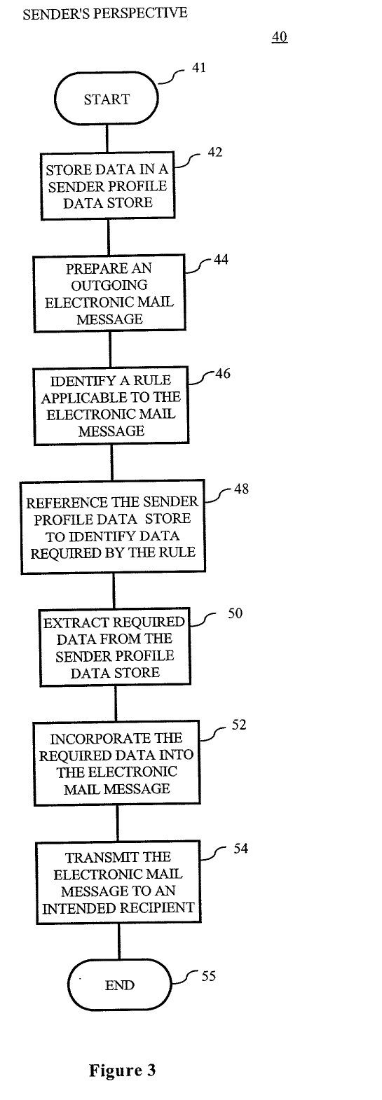

FIG. 3 is a flow diagram of an exemplary rule-based electronic mail transaction in accordance with a second embodiment of the present invention, shown from the sender's perspective. In the example of FIG. 3, the rule requires data elements retrieved from a sender profile data store storing sender-specific data. For example, the sender profile data store may be stored locally, at the sender's communications device, or at a remote location accessible via a communications network. As shown in FIG. 3, the method starts with storing of data, e.g. sender-specific data, in a sender profile data store. For illustrative purposes, consider that the sender-specific data store includes the sender's bank account number (0192837465) stored in association with a “BANK ACCOUNT NUMBER—SENDER” data element.

The sender then prepares an outgoing electronic mail message and identifies, e.g. specifies (either explicitly or pursuant to an automated process of the sender's e-mail program or otherwise), a rule applicable to the electronic mail message, as shown at steps 44 and 46 in FIG. 3 and as described above.

For illustrative purposes, consider that the sender wishes to send $100 to a recipient as a gift for the recipient's birthday. Accordingly, that the sender prepares a check-associated form of electronic mail message by typing “Happy Birthday! Don't spend it all in one place.” Also consider a “CHECK” rule which requires the following data elements from the sender: AMOUNT, BANK ACCOUNT NUMBER—SENDER; and the following data elements from the recipient: the RECIPIENT FULL NAME, the RECIPIENT BANK ACCOUNT NUMBER, and the RECIPIENT BANK ABA ROUTING NUMBER.

When the sender attempts to send the message to conduct a predefined CHECK transaction, inventive software stored and running on the sender's communications device identifies the CHECK rule as applicable to the electronic mail message. In this example, a data store of rules (whether stored on a sender's device or available via a communications network at a trusted authority, ESP, on a distributed basis, or otherwise) is referenced to identify data elements required by the CHECK rule, as shown at step 48. Alternatively, the rule may be contained within the message, as described above.

It is determined that data corresponding to the BANK ACCOUNT NUMBER—SENDER data element is absent from the electronic mail message. Accordingly, sender-specific data associated with the BANK ACCOUNT NUMBER—SENDER data element is identified and extracted from the sender profile data store, as shown in step 50.

In the example of FIG. 3, it is also determined that additional data corresponding to an additional data element (AMOUNT) is absent from the electronic mail message. It is further determined that amount data corresponding to the additional data element is absent from the sender profile data store. This is because there is no one amount that is worth storing as an AMOUNT data element in the sender profile—checks can be of different amounts every time. Accordingly, the sender is prompted to provide additional data to specify the amount of the check. In this example, the sender indicates an amount of $100.

This represents an improvement over free-form e-mail communications of the prior art, in which these data elements would have been missing and the transaction could not be completed.

In one embodiment, the sender is prompted to store the additional data in association with the additional data element in the sender profile data store. In the example of FIG. 3, the sender chooses not to do so.

The data for the required data elements is then associated with, e.g. incorporated, into the electronic mail message, as shown at step 52. For example, this may include the display of the data on the sender's communications device, storing the data in association with the electronic mail message and/or otherwise modifying the electronic mail message.

The electronic mail message is then transmitted to the intended recipient, as shown at step 54. In the example of FIG. 3, the electronic mail message is transmitted with the amount of the check ($100) and the sender's bank account number (0192837465) and will be ready for processing once data for the data elements required from the recipient are obtained from the recipient profile data store, as described above in reference to FIG. 2.

The transaction then ends, as shown at step 55 of FIG. 3.

Consider an additional illustrative example of a purchase transaction defined by a PURCHASE rule requiring an item ID code (such as a UPC code or a product number), buyer name, shipping address, credit card number and digital signature. Suppose a buyer views an infomercial or commercial, browses a website, sees an advertisement, receives an e-mail, page or instant message, or otherwise obtains an item ID code of a product he wishes to purchase, e.g. a beauty product (retail price $29.95). For example, this PURCHASE transaction could be used with Macy's department store's website to purchase the beauty product via electronic mail messaging, rather than via a Web-based connection of the type generally known in the prior art. In accordance with the present invention, a buyer could simply send an electronic mail message, e.g. with no text other than the item ID code, by specifying the PURCHASE rule as applicable to the message. Provided that the buyer's name, shipping address, credit card number and a digital certificate (for preparing a digital signature) are stored on or otherwise accessible to the buyer's communications device, such information is automatically retrieved and associated with the message by a software (or other) process controlling communications via the buyer's communications device before the message is sent. Alternatively, such information can be retrieved from an intermediary storing such information after the message is sent, e.g., before receipt by the recipient. Advantageously, such information can be stored once by the buyer and reused for numerous transactions without retyping or otherwise expending effort to resupply such information. None of this information need be stored at the seller's (Macy's) databases prior to the transactions which minimizes burdens on the seller and protects the buyer's privacy.

It should be noted that the present invention might be advantageously used for a broad range of non-monetary transactions. For example, the present invention could be used to obtain a dinner reservation at a favorite restaurant using a scheduling transaction. For example, an individual wishing to have a 6:00 pm dinner could prepare an electronic mail message by typing the text “6:00 p.m.” and associate a SCHEDULING rule with the message. The SCHEDULING rule may define a scheduling transaction as requiring the following data elements: the name of the sender, the sender's preference for “smoking” or “non-smoking” seating, the sender's telephone number for confirmation purposes and a date and time for the meeting. When the individual attempts to send the message, a software process checks that the data elements required by the rule are stored in the message. Assume that the teacher's name (Jane Doe), seating preference (non-smoking) and telephone number (999-999-9999) are stored in a private profile data store on the individual's communications device. Accordingly, such data elements are stored in the message without a need for action on the part of the individual. In one embodiment, the individual is given an opportunity to confirm before sending. Assume that the date and time data elements cannot be found in the data store. This is likely, because such data is unique to this single message. Accordingly, the software process scans the message for date and time data and finds the time data. For example, this may be identified by formatting, associated text (not included in the example above, programming flags or other codes, etc.). The software process then prompts the individual to enter a date for the reservation. The message is then sent to the restaurant. In this example, all required data elements are visible to the restaurant in the electronic mail message, although such is not always the case.

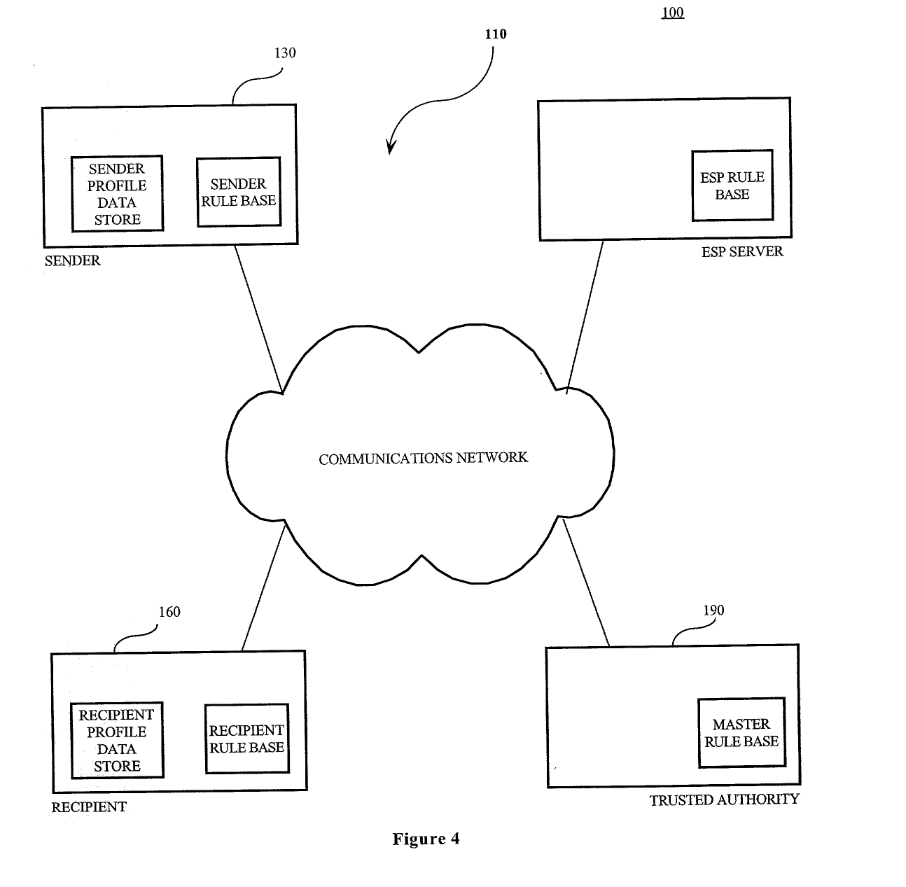

The method of the present invention may be implemented through the use of an electronic mail transaction system including one or more computers having typical hardware and/or specially configured software. FIG. 4 is a block diagram 100 of an electronic mail transaction system 110 in accordance with the present invention. The electronic mail system transaction 110 includes subscriber devices, such as a sender device 130, and/or a recipient device 160, and a trusted authority device 190 interconnected by a communications network, such as the Internet.

The hardware of the sender device, receiver device and trusted authority device are of types generally known in the art. The sender device 130 may be any device capable of sending electronic mail messages. For example, the sender device 130 may include a general purpose computer configured with mail composing or instant messaging software, a pager, a wireless telephone, a wireless personal digital assistant device such as a Palm VII® device, etc. The receiver device 160 may be any device capable of receiving electronic mail messages, such as a general purpose computer configured with mail reader software, a pager, a wireless telephone, a wireless personal digital assistant device such as a Palm VII® device, etc. Each of these devices 130, 160 includes a central processing unit (“CPU”), a memory, e.g., random access memory (“RAM”), read only memory (“ROM”) and/or a storage device such as a hard disk drive, and a telecommunications device for communicating via a communications network, e.g., using TCP/IP technology. The telecommunications device may include a modem and/or a network card connected via a communications port. Each device may optionally include a video display device and/or input devices.

The subscriber device 130, 160 stores in its memory a first program executable by the CPU for identifying a rule applicable to an electronic mail message; a second program executable by the CPU for identifying at least one data element required for said rule, a third program executable by the CPU for retrieving from a first data store data corresponding to the at least one data element, and a fourth program executable by the CPU for associating the data with said electronic mail message. The fourth program may optionally include instructions for transmitting the electronic mail message including data corresponding to the at least one data element.

Each subscriber device 130, 160 may optionally store in its memory a first data store storing data corresponding to at least one data element, the data being specific to a subscriber, and/or a second data store storing at least one rule specifier corresponding to a respective rule relating to the data element.

The trusted authority device 190 includes a central processing unit, a memory operatively connected to the central processing unit, a telecommunications device operatively connected to said central processing unit and capable of communicating via a communications network, and a master data store stored in its memory. The master data store stores a plurality of rules. Each of the plurality of rules relates to at least one data element. The trusted authority also stores in its memory a first program executable by the CPU for transmitting at least one of the plurality of rules via said communications network, e.g. to one or more subscribers. The trusted authority device 190 may also store in its memory data stores storing data relating to various users of the system.

The trusted authority device 190 may also store in its memory a second program executable by the CPU for storing the rule in its master data store and/or a third program for receiving an additional rule via a communications network.

In alternate embodiments, the sender profile data store, recipient profile data store, and/or all rule bases may be stored at the trusted authority device, ESP server and/or otherwise on a distributed, network accessible, basis.

It is noted that the present invention may be advantageously combined with a dynamic prioritization system and/or categorization system such as that disclosed in U.S. application Ser. No. ______ titled Method And Apparatus For Dynamic Prioritization of Electronic Mail Messages (Attorney Docket No. P24773 USA), filed ______, now U.S. Pat. No. ______, issued ______, or a spam routing system such as that disclosed in U.S. application Ser. No. ______ titled Method And Apparatus For Selective Delivery And Forwarding of Electronic Mail (Attorney Docket No. P24618 USA), filed ______, now U.S. Pat. No. ______, issued ______, the disclosures of which are incorporated herein by reference. Additionally, the present invention may be advantageously combined with methods and apparatuses for rule-based processing of electronic mail messages as disclosed in U.S. application Ser. No. ______ titled System and Method for Rule-based Processing of Electronic Mail Messages (Attorney Docket No. P24528 USA), filed ______, now U.S. Pat. No. ______, issued ______ and U.S. application Ser. No. ______ titled Reply Based Electronic Mail Transactions (Attorney Docket No. P24763 USA), filed ______, now U.S. Pat. No. ______, issued ______, the disclosures of which are incorporated herein by reference.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for conducting a predefined transaction via electronic mail messaging, the method comprising the steps of:
(a) identifying a rule applicable to an electronic mail message;
(b) identifying at least one data element required for compliance with said rule;
(c) retrieving from a first data store data corresponding to said at least one data element; and
(d) associating said data with said electronic mail message.

2. The method of claim 1, wherein said electronic mail message comprises said rule.

3. The method of claim 1, wherein step (a) comprises the step of:
(e) referencing a second data store of rule specifiers, each of said rule specifiers corresponding with a respective rule; and
(f) scanning said electronic mail message for a rule specifier stored in said data store.

4. The method of claim 3, wherein step (a) comprises the step of:
(g) identifying a rule specifier in a header portion of said electronic mail message

5. The method of claim 3, wherein said second data store is stored locally.

6. The method of claim 3, wherein said second data store is referenced via a communications network.

7. The method of claim 1, further comprising the steps of:
(h) storing in said first data store data corresponding to a plurality of data elements, said data being specific to a recipient of said electronic mail message; and
(i) receiving said electronic mail message;
steps (h) and (i) being performed before step (b).

8. The method of claim 7, wherein said first data store is stored locally.

9. The method of claim 7, wherein said first data store is referenced via a communications network.

10. The method of claim 7, wherein step (d) comprises the step of:
(j) displaying said data in association with said electronic mail message.

11. The method of claim 7, wherein step (d) comprises the step of:
(k) storing said data in association with said electronic mail message.

12. The method of claim 7, wherein step (d) comprises the step of:
(l) modifying said electronic mail message to include said data; and
(m) transmitting said electronic mail message.

13. The method of claim 12, wherein said rule requires data elements retrieved from said first data store and a third data store, said third data store storing data corresponding to said plurality of data elements, said data being specific to a party other than said recipient.

14. The method of claim 1, further comprising the steps of:
(n) storing in said first data store data corresponding to a plurality of data elements, said data being specific to a sender of said electronic mail message; and
(o) preparing said electronic mail message;
steps (n) and (o) being performed before step (b).

15. The method of claim 14, wherein step (d) comprises the step of:
(p) displaying said data in association with said electronic mail message.

16. The method of claim 14, wherein step (d) comprises the step of:
(q) storing said data in association with said electronic mail message.

17. The method of claim 14, wherein step (d) comprises the step of:
(r) modifying said electronic mail message to include said data; and
(s) transmitting said electronic mail message.

18. A method for conducting a predefined transaction via electronic mail messaging, the method comprising the steps of:
(a) identifying a rule applicable to an electronic mail message, said rule requiring said electronic mail message to include data corresponding to at least one data element;
(b) determining that data corresponding to said at least one data element is absent from said electronic mail message;
(c) retrieving said data corresponding to said at least one data element from a first data store; and
(d) modifying said electronic mail message to include said data.

19. The method of claim 18, further comprising the step of:
(e) transmitting said electronic mail message, step (e) being performed after step (d).

20. The method of claim 18, further comprising the step of:
(f) displaying said electronic mail message, step (e) being performed after step (d).

21. The method of claim 18, wherein said first data store is stored locally.

22. The method of claim 18, wherein said first data store is accessed via a communications network.

23. The method of claim 18, wherein said rule is embedded in said electronic mail message.

24. The method of claim 18, wherein step (a) comprises the steps of:
(h) identifying a rule specifier included in said electronic mail message; and
(i) referencing a second data store of rule specifiers to identify said rule.

25. The method of claim 24, wherein said second data store is stored locally.

26. The method of claim 24, wherein said second data store is accessed via a communications network.

27. The method of claim 24, wherein step (h) comprises identifying said rule specifier in header information of said electronic mail message.

28. The method of claim 24, wherein step (h) comprises identifying said rule specifier in a content portion of said electronic mail message.

29. The method of claim 18, wherein said rule requires said electronic mail message to include additional data corresponding to at least one additional data element, said method further comprising the steps of:
(j) determining that additional data corresponding to said at least one additional data element is absent from said electronic mail message;
(k) determining that said additional data corresponding to said additional data element is absent from said first data store;
(l) prompting a user to provide said additional data; and
(m) modifying said electronic mail message to include said additional data.

30. The method of claim 29, further comprising the step of:
(n) prompting said user to store said additional data in association with said additional data element in said first data store.

31. A device for conducting a predefined transaction via electronic mail messaging, the device comprising:
a central processing unit;
a memory operatively connected to said central processing unit;
a telecommunications device operatively connected to said central processing unit and capable of communicating via a communications network;
a first program stored in said memory and executable by said central processing unit for identifying a rule applicable to an electronic mail message;
a second program stored in said memory and executable by said central processing unit for identifying at least one data element required for said rule;
a third program stored in said memory and executable by said central processing unit for retrieving from a first data store data corresponding to said at least one data element; and
a fourth program stored in said memory and executable by said central processing unit for associating said data with said electronic mail message.

32. The device of claim 31, further comprising:
a first data store stored in said memory, said first data store storing data corresponding to said at least one data element, said data being specific to a subscriber; and
a second data store stored in said memory, said second data store storing at least one rule specifier corresponding to a respective rule relating to said at least one data element.

33. The device of claim 31, wherein said fourth program comprises instructions for transmitting said electronic mail message comprising said data corresponding to said at least one data element.

34. A device for facilitating predefined transactions via electronic mail messaging, the device comprising:
a central processing unit;
a memory operatively connected to said central processing unit;
a telecommunications device operatively connected to said central processing unit and capable of communicating via a communications network;
a data store stored in said memory, said data store storing at least one rule relating to at least one data element;
a first program stored in said memory and executable by said central processing unit for storing said rule in said data store; and
a second program stored in said memory and executable by said central processing unit for transmitting said rule via a communications network.

35. The device of claim 34, further comprising:
a third program stored in said memory for receiving an additional rule via a communications network.

36. An electronic mail transaction system, the system comprising:
a trusted intermediary device comprising:
a central processing unit;
a memory operatively connected to said central processing unit;
a telecommunications device operatively connected to said central processing unit and capable of communicating via a communications network;
a master data store stored in said memory, said master data store storing a plurality of rules, each of said plurality of rules relating to at least one data element;
a first program stored in said memory and executable by said central processing unit for transmitting at least one of said plurality of rules via said communications network; and
a subscriber device capable of communicating with said trusted intermediary device via said communications network, said subscriber device comprising:
a central processing unit;
a memory operatively connected to said central processing unit;
a telecommunications device operatively connected to said central processing unit and capable of communicating via said communications network;
a first subscriber data store stored in said memory, said first subscriber data store storing said at least one of said plurality of rules;
a second subscriber data store stored in said memory, said second subscriber data store storing data relating to said at least one data element, said data being specific to said recipient;
a first program stored in said memory and executable by said central processing unit for identifying said at least one of said plurality of rules as applicable to an electronic mail message;
a second program stored in said memory and executable by said central processing unit for identifying said at least one data element as required for said at least one of said plurality of rules;
to a third program stored in said memory and executable by said central processing unit for retrieving said data relating to said at least one data element from said second subscriber data store; and
a fourth program stored in said memory and executable by said central processing unit for associating said data relating to said at least one data element with said electronic mail message.

37. The method of claim 1, wherein step (a) comprises the step of:
(e) referencing a second data store of rule specifiers, each of said rule specifiers corresponding with a respective rule; and
(f) scanning said electronic mail message for a rule specifier stored in said data store.

38. The method of claim 37, wherein step (a) comprises the step of:
(g) identifying a rule specifier in a header portion of said electronic mail message; and
(h) identifying a rule specifier in network forwarding instructions.

39. The method of claim 38, further comprising the step of:
(i) transmitting said electronic mail message in accordance with instructions specified by a rules associated with said rule specifier.
